(19) United States
(12) Patent Application Publication
(10) Pub. No.: US 2004/0011191 A1
(43) Pub. Date: Jan. 22, 2004

(54) Method and circuit for creating a sub-harmonic of a periodic signal

(76) Inventor: Erik Larsen, Urbana (NL)

Correspondence Address: PHILIPS INTELLECTUAL PROPERTY & STANDARDS, P.O. BOX 3001, BRIARCLIFF MANOR, NY, 10510, US

(21) Appl. No.: 10/233,456

(22) Filed: Sep. 3, 2002

(30) Foreign Application Priority Data
Sep. 6, 2001 (EP) 01203362.7

(51) Int. Cl. G10H 1/12; G10H 5/00

(52) U.S. Cl. 84/699

(57) ABSTRACT

The invention relates to a method and a circuit (500) for generating a sub-harmonic of a periodic signal (100). Conventional methods of generating sub-harmonics of a periodic signal, e.g. for bass enhancement of audio signals, create considerable artefacts. This affects the timbre, the color of the audio signal. The invention presents a method of generating a sub-harmonic of a periodic signal (100) which, added to the original audio signal, produces a more natural audio signal with bass enhancement. In a first embodiment of the invention, the signal (100) is clipped at a first predetermined level (a) in every second period (116) of the signal when the amplitude of the signal is larger than a second predetermined level. In a second embodiment of the invention, the signal is clipped at a second level (a) in every first period (115) and at a third level (b) in every second period (116) of the signal, provided that the signal level exceeds a first predetermined level.

The invention relates to a method of creating at least a sub-harmonic of a periodic signal.

The invention also relates to a circuit for generating at least a sub-harmonic of a periodic signal.

The invention further relates to an apparatus for reproducing audio signals, the apparatus comprising a circuit for generating at least a sub-harmonic of a periodic signal.

The invention also relates to a record carrier comprising instructions which can be carried out by a processor and enable this processor to generate at least a sub-harmonic of a periodic signal.

An embodiment of such a method is known from U.S. Pat. No. 3,535,969. This document discloses a circuit for processing electronic tones of musical instruments, which circuit generates a periodic output signal with reference to a periodic input signal at a frequency which is half or a quarter of the frequency of the input signal.

The known method has the drawback that an output signal is generated with unwanted artefacts. This affects the quality of the processed sound signal.

It is an object of the invention to eliminate at least a part of the unwanted artefacts.

According to the invention, this object is achieved in that only sub-harmonics are created if the amplitude of the signal is larger than a predetermined level.

By generating only sub-harmonics of only the strong parts of the signal rather than of the weaker parts of the signal, it is prevented that, when using the invention in, for example, bass enhancement operations, the enhanced signal lags too long.

An embodiment of the method according to the invention is characterized in that the signal is clipped at a first level in an even period and at a second level in an odd period.

This embodiment has the advantage that different properties regarding bass enhancement can be chosen for signals with different strengths, because there is freedom of choosing two variables.

An embodiment of the method according to the invention is characterized in that the method comprises the step of generating higher harmonics of the sub-harmonic if the amplitude of the periodic signal is larger than a predetermined further level.

This embodiment has the advantage that it has been found that bass enhancement of an audio signal by spectrum widening yields a better result when, during generation of lower harmonics, also higher harmonics of the lower harmonics are generated.

The circuit according to the invention is characterized in that the circuit is adapted to generate only the sub-harmonic of the signal when the amplitude of the signal is larger than a predetermined level.

The apparatus according to the invention is characterized in that the apparatus comprises the circuit according to the invention.

The record carrier comprising instructions which can be carried out by a processor according to the invention is characterized in that the instructions enable the processor to perform the method according to the invention.

These and other aspects of the invention are apparent from and will be elucidated with reference to the embodiments described hereinafter.

In the drawings:

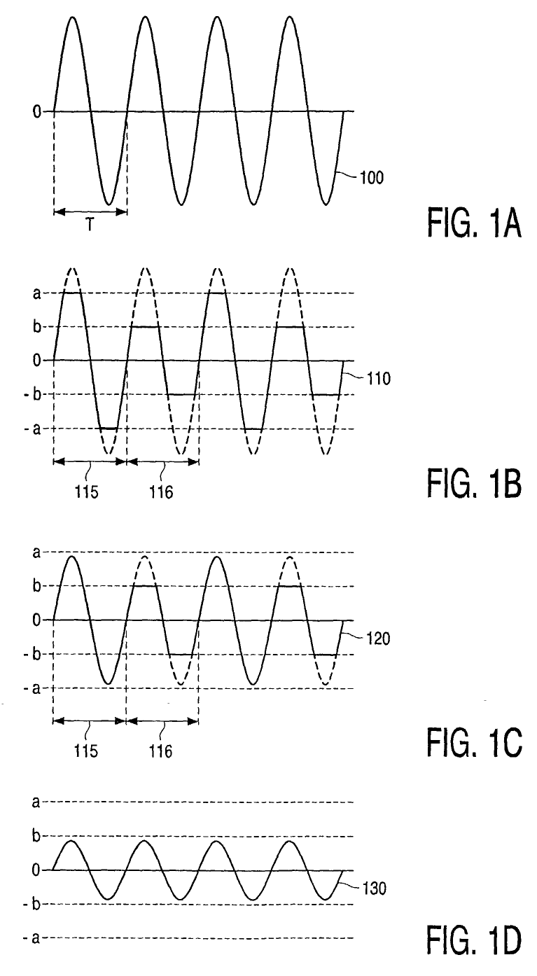

FIG. 1 shows four signals to illustrate embodiments of the method according to the invention;

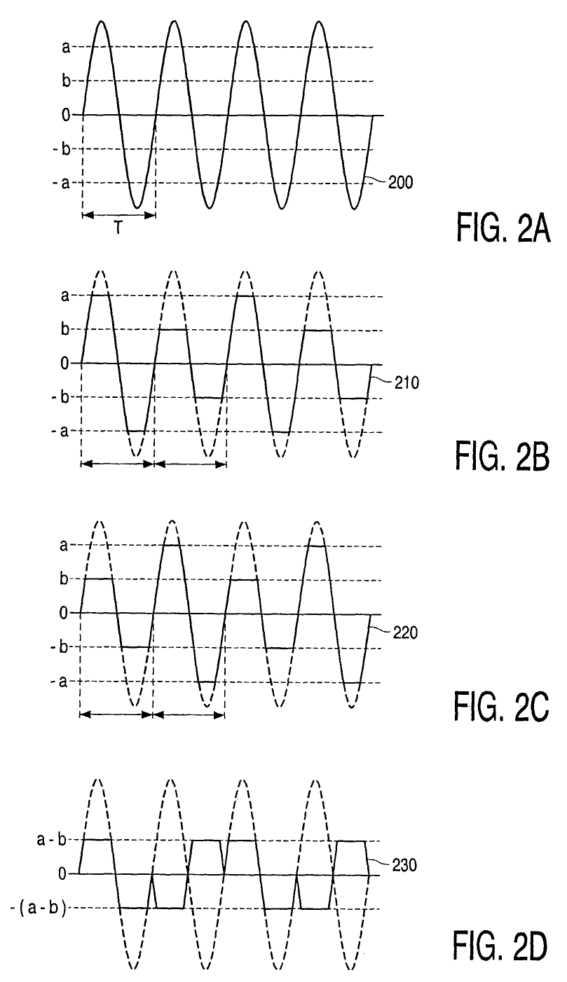

FIG. 2 shows four signals to illustrate a further embodiment of the method according to the invention;

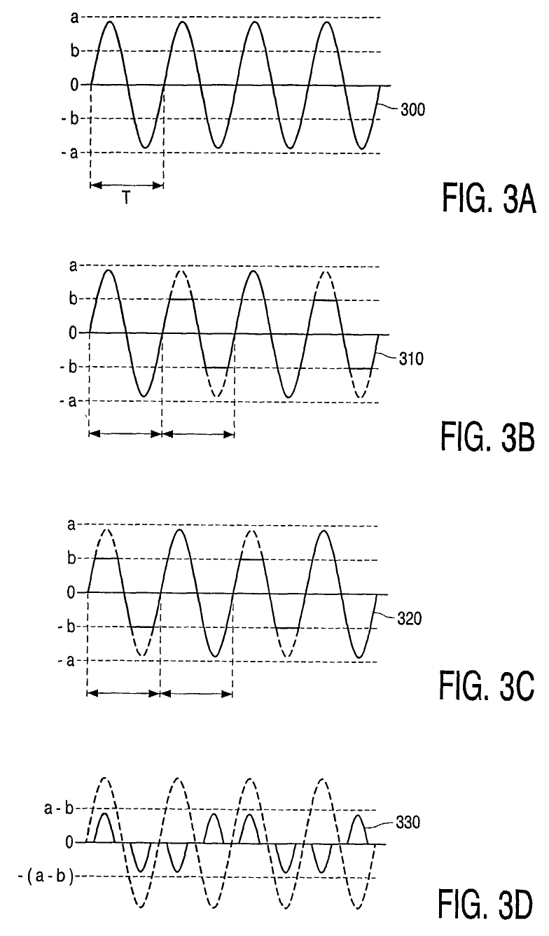

FIG. 3 shows four signals to illustrate a further embodiment of the method according to the invention;

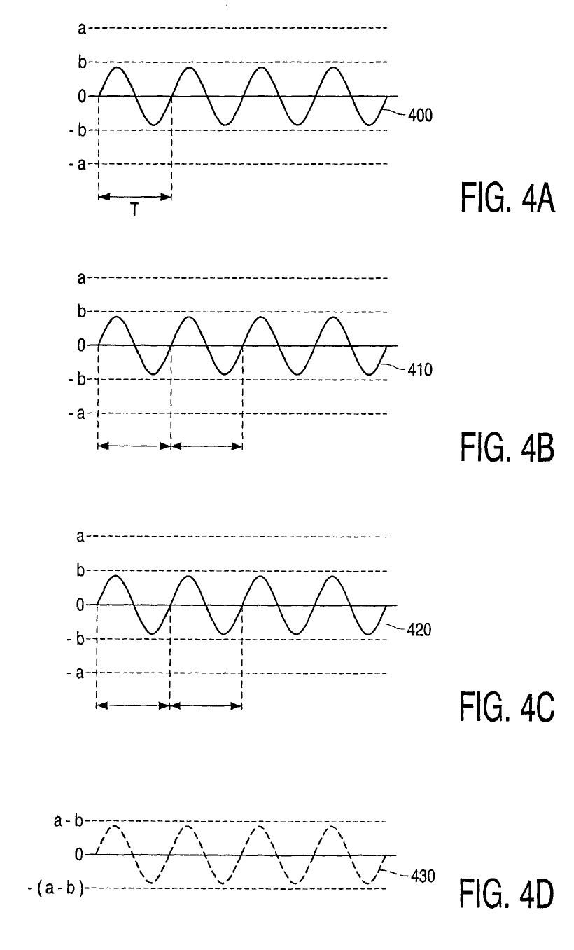

FIG. 4 shows four signals to illustrate a further embodiment of the method according to the invention;

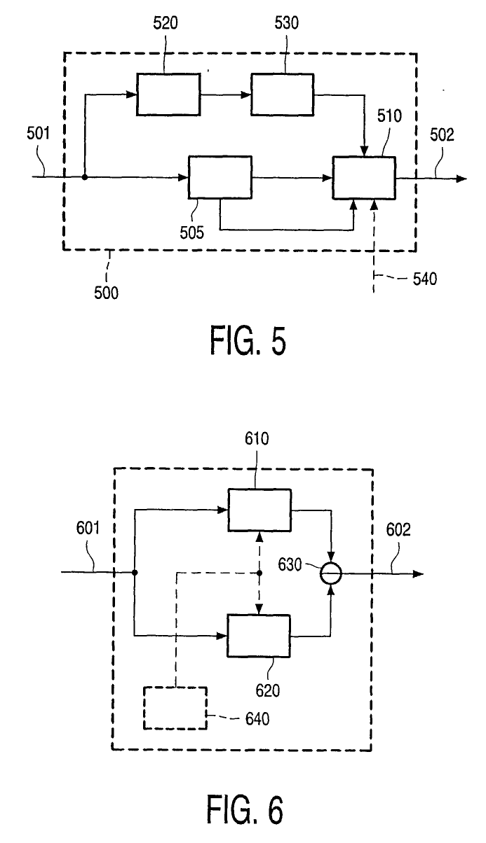

FIG. 5 shows an embodiment of the circuit according to the invention;

FIG. 6 shows a further embodiment of the circuit according to the invention;

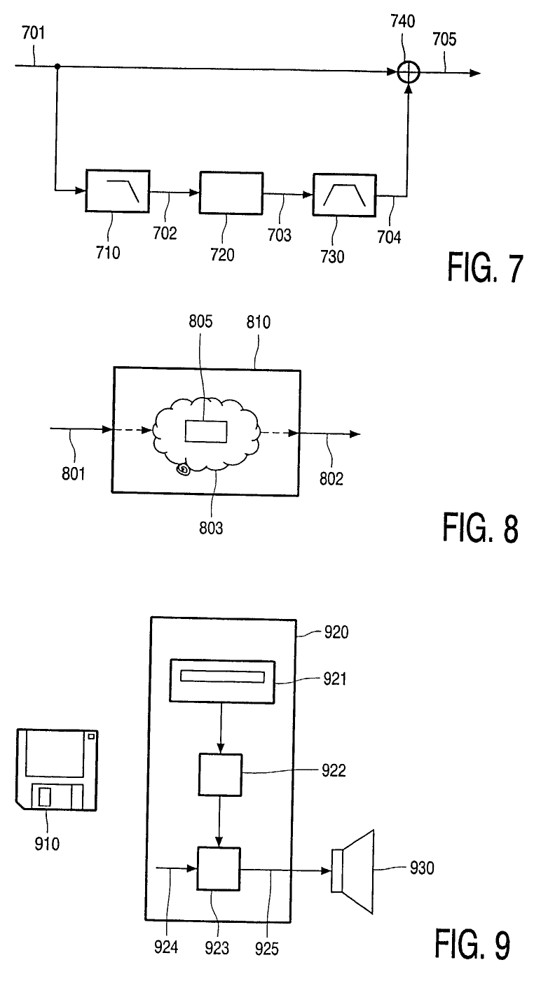

FIG. 7 illustrates a circuit for use of the invention;

FIG. 8 shows an embodiment of the apparatus according to the invention;

FIG. 9 shows an embodiment of the record carrier comprising instructions which can be carried out by a processor according to the invention, and a diagrammatical representation of a computer comprising the processor;

FIG. 1A shows an original periodic signal 100 having a period T[s] and a frequency 1/T[Hz]. FIGS. 1B, 1C and 1D show embodiments of the method according to the invention.

FIG. 1B shows an embodiment of the method of making a lower harmonic of the original periodic signal 100 if the amplitude of the original periodic signal 100 is larger than a predetermined first level a. According to this embodiment, the original periodic signal is clipped at the predetermined first level a in a first period 115 and at a predetermined second level b in a second period 116. In this way, a first sub-harmonic signal 110 is obtained at a frequency which is half the frequency of the original periodic signal 100. In addition, in this embodiment of the method according to the invention, higher harmonics of the first sub-harmonic signal 110 are generated. The values of the amplitude of the different harmonics are given by relation (1) in which a₁ is the amplitude of the generated sub-harmonic. When setting up amplitude relation (1), the waveform of the first processed signal 110 is approximated by a rectangular waveform having the predetermined first level a during the first period 115 and the predetermined second level b during the second period 116. Relation (1) is therefore only an approximation.

$${a}_{k} = \frac{2 i}{π k} {ⅇ}^{- \frac{ⅈ π k}{2}} \{ a {sin}^{2} ( \frac{π k}{4} ) + {( - 1 )}^{k} b {sin}^{2} ( \frac{3 π k}{4} ) \} , k ∈ {+}^{} \qquad ( 1 )$$

In a preferred embodiment of the method according to the invention, the decision whether a signal must be clipped or not clipped is given by counting the number of zero-crossings of the signal (100). For example, the level at which the first processed signal 110 is clipped changes every second zero-crossing. In a further embodiment of the method according to the invention, the level at which a signal is clipped may alternatively change every third, fourth or further zero-crossing.

FIG. 1C shows a further embodiment of the method of making a periodic signal of the original periodic signal 100 at a frequency which is half the frequency of the original periodic signal 100 if the amplitude of the original periodic signal is smaller than the predetermined first level a and larger than the predetermined second level b. In accordance with this embodiment, the original periodic signal is not clipped in the first period 115 and is clipped at a second predetermined level b in a second period 116. In this way, a second sub-harmonic signal 120 is obtained at a frequency which is half the original periodic signal 100. In addition, in this embodiment of the method, higher harmonics of the first processed signal 120 are generated.

The ratios between the higher harmonics of the second sub-harmonic signal 120 and the fundamental harmonic of the second sub-harmonic signal 120 are, however, lower than the ratios between the higher harmonic of the first processed signal 110 and the fundamental harmonic of the first processed signal 110. This has the advantage that, if the presented method is used for bass enhancement, the generated sound sounds much more naturally than in the case where the ratios between the higher harmonics and the fundamental harmonic would be equal for signals having different amplitudes.

FIG. 1D shows a periodic signal 130 having an amplitude which is smaller than the second predetermined level b. Since the amplitude of the further periodic signal 130 is smaller than the second predetermined level b, no sub-harmonics of the periodic signal 130 are generated.

FIG. 2A shows an original periodic signal 200 with a period having a duration T[s] and a frequency 1/T[Hz]. The amplitude of the original periodic signal 200 is larger than the predetermined first level a. FIGS. 2B, 2C and 2D show different waveforms illustrating a further embodiment of the method according to the invention.

FIG. 2B shows a first processed signal 210, denoted by the solid line, which is obtained by processing the original periodic signal 200 in accordance with the embodiment of the method described with reference to FIG. 1B. FIG. 2C shows a second processed signal 220, denoted by the solid line, which is obtained in a similar method, in which clipping at the predetermined first level a has been replaced by clipping at the predetermined second level b, and vice versa. It is alternatively possible to obtain the second processed signal 220 from the first processed signal 210 by delaying the first processed signal 210 with a time duration of T[s]. However, this embodiment has a number of drawbacks. One of the greatest problems is that the duration T is not known in advance. It would take much trouble to trace the duration T. The duration T is also time-variant, which would necessitate a time-variant delay.

Subsequently, the first processed signal 210 is subtracted from the second processed signal 220 in accordance with the embodiment of the method according to the invention. In this way, a third processed signal 230, denoted by the solid line, is obtained. The third processed signal 230 has a fundamental harmonic at a frequency which is half that of the fundamental harmonic of the original periodic signal 200. The sub-harmonic and the odd harmonics of this sub-harmonic are relatively much stronger with respect to the even harmonics of the sub-harmonic, as compared with the method described with reference to FIG. 1. This can be checked with reference to relation (1). It has a favorable effect on the ultimate result.

FIGS. 3 and 4 show different waveforms to illustrate the same embodiment of the method according to the invention for an original periodic signal, if the amplitude of the original periodic signal is smaller than the predetermined first level a and larger than the predetermined second level b (FIG. 3) and if the amplitude of the original periodic signal is smaller than the predetermined second level b (FIG. 4, respectively).

FIG. 3A shows an original periodic signal 300 with a period having a time duration T[s] and a frequency 1/T[Hz]. The amplitude of the original periodic signal 300 is smaller than the predetermined first level a and larger than the predetermined second level b.

FIG. 3B shows a first processed signal 310, denoted by the solid line, which is obtained by processing the original periodic signal 300 in accordance with the embodiment of the method described with reference to FIG. 1. FIG. 3C shows a second processed signal 320, denoted by the solid line, which is obtained in a similar method, in which clipping at the predetermined first level a has been replaced by clipping at the predetermined second level b, and vice versa. It is alternatively possible to obtain the second processed signal 320 from the first processed signal 310 by delaying the first processed signal 310 by a time duration of T[s]. Subsequently, the first processed signal 310 is subtracted from the second processed signal 320 in accordance with the embodiment of the method according to the invention. In this way, a third processed signal 330, denoted by the solid line, is obtained. The third processed signal 330 has a fundamental harmonic at a frequency which is half that of the fundamental harmonic of the original periodic signal 300.

FIG. 4A shows an original periodic signal 400 with a period having a time duration T[s] and a frequency 1/T[Hz]. The amplitude of the original periodic signal 400 is smaller than the predetermined second level b.

FIG. 4B shows a first processed signal 410, denoted by the solid line, which is obtained by processing the original periodic signal 400 in accordance with the embodiment of the method described with reference to FIG. 1. Since the amplitude of the original periodic signal is smaller than the second predetermined level, the first processed signal is equal to the original periodic signal 400. This also applies to a second processed signal 420. Subsequently, the first processed signal 410 is subtracted from the second processed signal 420 in accordance with the embodiment of the method according to the invention. In this way, a third processed signal 430, denoted by the solid line, is obtained. Since the first processed signal 410 and the second processed signal 420 are equal, the third processed signal 430 is equal to 0.

In the presented embodiment of the invention, the amplitudes of the first processed signal 410 and the second processed signal 430 are equal. In a further embodiment of the invention, at least one of these two signals is amplified or attenuated so that the third processed signal 430 is not equal to 0.

In the presented embodiments of the method according to the invention, threshold values of the amplitudes of signals at which clipping must take place are equal to the clipping levels. However, it is alternatively possible that these values do not correspond. In that case, a signal is clipped at a first predetermined level if the amplitude is larger than a second predetermined level. In a further embodiment of the invention, the threshold values of the amplitude of signals which must be clipped and the levels at which clipping takes place are adjustable.

In a further embodiment of the invention, the values of the different levels are derived from the amplitude of the original periodic signal (100). The methods described work best when the original periodic signal does not comprise a DC component. It is therefore recommended to remove a possible DC component from a signal before this signal is processed.

FIG. 5 shows a circuit 500 as an embodiment of a circuit for performing the method according to the invention, presented with reference to FIG. 1. The circuit 500 comprises an amplitude detector 505, clipping means 510, a zero-crossing detector 520 and counting means 530. An original periodic signal is applied to an input 501 of the circuit 500. In the zero-crossing detector 520, the signal is tested at a zero-crossing by means of a method which is known per se. In the case of a zero-crossing in the original periodic signal applied to the input 501, the zero-crossing detector 520 supplies a signal to the counting means 530. The counting means 530 are adapted to indicate to the clipping means 510 whether the original periodic signal applied to the input 501 must be clipped or not clipped. This may be effected after every second zero-crossing, or after every third, fourth, fifth or further zero-crossing. In a further embodiment, the counting means 530 indicate to the clipping means 510 at which level the original periodic signal must be clipped. The amplitude of the original periodic signal is measured in the amplitude meter 505. Moreover, it is determined with reference to the measured amplitude whether the original periodic signal must be clipped or not clipped. An optional alternative is a supply channel 540 with which the clipping level and/or the threshold value from which the original periodic signal must be clipped can be adjusted. In this way, it can be indicated with the circuit 500 per period for a periodic signal whether and at what level the signal must be clipped.

FIG. 6 shows a circuit 600 as a further embodiment of a circuit for performing the method described with reference to FIGS. 2A through 4D. The circuit 600 comprises a first harmonic generator 610, a second harmonic generator 620 and subtraction means 630. The operation of the first harmonic generator 610 and the second harmonic generator 620 has been explained with reference to FIG. 2. If the original periodic signal 200 is applied to the first harmonic generator 610 and to the second harmonic generator 620 via an input 601 of the circuit 600, the first harmonic generator 610 generates the first processed signal 210 and the second harmonic generator 620 generates the second processed signal 220. The subtraction means 630 are adapted to subtract the output signals of the first harmonic generator 610 from the output signals of the second harmonic generator 620. The output signal of the first harmonic generator 610 is subtracted from the output signal of the second harmonic generator 620, or vice versa. This does not depart from the scope of the invention. In a further embodiment of the circuit according to the invention, the circuit 600 also comprises synchronizing means 640 for synchronizing the first harmonic generator 610 with the second harmonic generator 620.

FIG. 7 shows a circuit 700 as a possibility of using the invention. The circuit 700 comprises a low-pass filter 710, a harmonic generator 720, a bandpass filter 730 and adding means 740. An input signal 701 is applied to the input of the circuit 700. In the embodiment shown, the low-pass filter 730 passes only frequencies up to 120 Hz of the input signal 701. A first interim signal 702 comprising the frequencies up to 120 Hz of the input signal 701 is applied to the harmonic generator 720. It will be evident to those skilled in the art that said frequencies are only examples and that it is alternatively possible to choose different values. This does not depart from the scope of the invention. The harmonic generator 720 generates lower and higher harmonics of the harmonics in the interim signal 702 by means of the method according to the invention. The harmonic generator 720 generates a second interim signal 703 which is applied to the bandpass filter 730. The bandpass filter 730 is adapted to remove unwanted harmonics from the second interim signal. These may be lower harmonics which cannot be reproduced by a system incorporating the circuit 700. The bandpass filter 730 may, however, also be adapted in such a way that the harmonics of the second interim signal which are passed on by the bandpass filter 730 are adjustable. At the output of the bandpass filter 730, a third interim signal 704 is applied to the adding means 740. The adding means 740 add the third interim signal to the input signal 701. In this way, the circuit 700 generates an output signal 705. The circuit 700 may be used for applications as described in EP 0 240 286.

It will be evident to those skilled in the art that the circuit according to the invention may be both digital and analog.

In a further embodiment of the circuit according to the invention, the circuit 700 comprises a further bandpass filter instead of the low-pass filter 710. The further bandpass filter preferably passes signal components at frequencies between 40 Hz and 120 Hz.

The bandpass filter 730 of the circuit 700 may be an active filter. If this is the case, this active filter may be alternatively formed with a passive filter in series with amplifier means (not shown). This embodiment is preferred. The amplification of the amplifier means is preferably controllable. The control can be realized by making the amplification dependent on the output signal.

The processing in the lower branch of the circuit 700 results in a delay of the signal. To ensure that the original signal in the upper branch of the circuit 700 is delayed in the same way, a delay element (not shown) is incorporated in the upper branch of the circuit in a further embodiment of the circuit according to the invention. It will be easy to those skilled in the art to compute the delay of the lower branch of the circuit 700.

FIG. 8 shows an embodiment of the apparatus for reproducing audio signals according to the invention. The apparatus comprises input means 801, output means 802 and a system 803 comprising the circuit 805 according to the invention. Possible embodiments of the input means may be: RF antenna, SACD, DVD, CD, CD-ROM with, for example, MP3 files, tape cassettes, vinyl records or an electric or optical output signal of an apparatus adapted to convert information on a record carrier into an optical or electric signal. However, this enumeration is not limitative, as will be evident to those skilled in the art. Possible embodiments of the output means are a CD burner, an electric signal or an RF signal. However, also this enumeration is not limitative, as will be evident to those skilled in the art.

FIG. 9 shows a diskette 910 as an embodiment of a record carrier according to the invention, which diskette comprises instructions which can be performed by a processor and enable the processor to perform the method according to the invention. The record carrier 910 may be used in a computer 920. This may be a personal computer but also, for example, a Personal Digital Assistant or a UNIX workstation. The computer 920 comprises a diskette station 921 which is connected to a processor 922. The processor 922 is further connected to a signal-processing circuit 923 having an input 924 and an output 925. The diskette station 921 is adapted to read information from the diskette 910 and pass it on to the processor 922. The information comprises instructions which can be carried out by the processor 922 and enable the processor 922 to process, via the signal-processing circuit 923, an input signal at the input 924 of the signal-processing circuit 923 by means of the method according to the invention. The processed signal is subsequently passed on via the output 925 of the signal-processing circuit 923 to a loudspeaker 930 for the purpose of reproduction.

In the embodiment shown, the record carrier according to the invention is a diskette 910. However, the record carrier 910 may be alternatively a CD-ROM or a flash card but also a mass storage device which is coupled to a WAN such as the Internet. Another embodiment of the record carrier according to the invention is, however, also possible and does not depart from the scope of the invention.

In the description of the invention, a signal to be processed is presented as a periodic signal. However, in applications of the method and the circuit according to the invention, the signal to be processed will be, for example, music or speech. This type of signal is often defined as quasi-periodic. Although this is generally not a purely periodic signal, it will be evident to those skilled in the art that the original periodic signal 100 (FIG. 1) may also be, for example, a music or speech signal.

In summary, the invention relates to a method and a circuit (500) for generating a sub-harmonic of a periodic signal (100). Conventional methods of generating sub-harmonics of a periodic signal, e.g. for bass enhancement of audio signals, create considerable artefacts. This affects the timbre, the color of the audio signal. The invention presents a method of generating a sub-harmonic of a periodic signal (100) which, added to the original audio signal, produces a more natural audio signal with bass enhancement. In a first embodiment of the invention, the signal (100) is clipped at a first predetermined level (a) in every second period (116) of the signal when the amplitude of the signal is larger than a second predetermined level. In a second embodiment of the invention, the signal is clipped at a second level (a) in every first period (115) and at a third level (b) in every second period (116) of the signal, provided that the signal level exceeds a first predetermined level.

1. A method of creating a sub-harmonic of a substantially periodic signal (100), characterized in that sub-harmonics are created only if the amplitude of the signal (100) is larger than a predetermined first level.

2. A method as claimed in claim 1, characterized in that the signal is clipped at a second predetermined level (a) in every second period.

3. A method as claimed in claim 1, characterized in that the signal (100) is clipped at a second predetermined level (a) in an odd period (115) and at a third predetermined level (b) in an even period (116).

4. A method as claimed in claim 1, characterized in that the method comprises the steps of:
clipping the periodic signal (100) at a second predetermined level (a) in an odd period (115) and at a third predetermined level (b) in an even period (116) to generate a second signal (210),
clipping the periodic signal (100) at the third predetermined level (b) in an odd period (115) and at the second predetermined level (a) in an even period (116), to generate a third signal (220),
subtracting the second signal (210) form the third signal (220).

5. A method as claimed in claim 4, characterized in that the method comprises at least one of the steps of:
scaling the second signal (210) at a predetermined value,
scaling the third signal (220) at a predetermined value.

6. A method as claimed in claim 1, characterized in that the method comprises the step of generating higher harmonics of the sub-harmonic if the amplitude of the periodic signal is larger than a predetermined further level.

7. A method as claimed in claim 1, characterized in that the first predetermined level is adjusted.

8. A method as claimed in claim 6, characterized in that the first predetermined level is adjusted in dependence upon the amplitude of the signal (100).

9. A circuit (500) for generating at least a sub-harmonic of a signal, characterized in that the circuit is adapted to generate only the sub-harmonic of the signal when an amplitude of the signal is larger than a predetermined level.

10. An apparatus for reproducing audio signals (810), characterized in that the apparatus comprises the circuit (500) as claimed in claim 9.

11. A record carrier (910) comprising instructions which can be carried out by a processor, characterized in that the instructions enable the processor to perform the method as claimed in claim 1.
